(19) United States
(12) Patent Application Publication
(10) Pub. No.: US 2016/0106061 A1
(43) Pub. Date: Apr. 21, 2016

(54) COMPONENT PET BED ASSEMBLY AND METHOD

(71) Applicant: pm&j, LLC, Plymouth, MN (US)

(72) Inventors: Gary Nelson, Plymouth, MN (US); Sara Pokorny, Plymouth, MN (US)

(21) Appl. No.: 14/884,284

(22) Filed: Oct. 15, 2015

Related U.S. Application Data
(60) Provisional application No. 62/064,651, filed on Oct. 16, 2014.

(51) Int. Cl. A01K 1/035

(52) U.S. Cl. CPC A01K 1/0353

(57) ABSTRACT

In one aspect, a pet bed includes an assembly of a plurality of separate cushion components and a shell containing the assembly. In another aspect, a method of assembling a pet bed includes inserting a plurality of separate cushion components into an opening of a shell, thereby forming within the shell an assembly comprising a single layer of cushion components.

### CROSS REFERENCE TO RELATED APPLICATION

This application claims the benefit of priority from U.S. Provisional Patent Application Ser. No. 62/064,651, filed on Oct. 16, 2014, entitled “Component Pet Bed Assembly and Method,” which is fully incorporated by reference.

### BACKGROUND

Pet beds are used to provide a resting place for pets, offering them a comfortable spot on which to lounge as an alternative to places such as the family's couch or bed. Pet owners sometimes prefer for their pets to have their own dedicated resting areas. One advantage of a resting area particularly suited to a pet is that fur, dander, and other pet sheddings are somewhat contained for ease of clean-up.

Pet beds conventionally comprise a cushion within a shell. The shell can have a selectively closeable opening, such as an opening closable with a zipper, for example. The opening facilitates insertion of the cushion and/or removal of the shell for cleaning or replacement. In some cases, the cushion is not an integral element but rather is a filling that may consist of fibers, such as polyester fiber-fill, for example.

During use, the fibers in a frequently used area of the pet bed, such as the middle, for example, may compact or be pushed to the periphery, thereby leaving a thin area having little cushioning material. This creates an inconsistent and uncomfortable surface over time. Such fill migration significantly shortens the useful service life of a pet bed.

### SUMMARY

In one aspect, a pet bed includes an assembly of a plurality of separate cushion components and a shell containing the assembly.

In another aspect, a method of assembling a pet bed includes inserting a plurality of separate cushion components into an opening of a shell, thereby forming within the shell an assembly comprising a single layer of cushion components.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views.

FIG. 1 is a front perspective view of an exemplary embodiment of a pet bed.

FIG. 2 is a side perspective view of the pet bed of FIG. 1.

FIG. 3 is a perspective view of cushion components for filling the shell of the pet bed of FIGS. 1 and 2.

FIG. 4A is a perspective view of a second exemplary embodiment of a cushion casing construction.

FIG. 4B is a perspective view of the cushion casing of FIG. 4A, wherein ends of the casing are closed.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art which fall within the scope and spirit of the principles of this disclosure.

The figures may not be drawn to scale. In particular, some features may be enlarged relative to other features for clarity. Moreover, where teems such as above, below, over, under, top, bottom, side, right, left, etc., are used, it is to be understood that they are used only for ease of understanding the description. It is contemplated that structures may be oriented otherwise.

### DETAILED DESCRIPTION

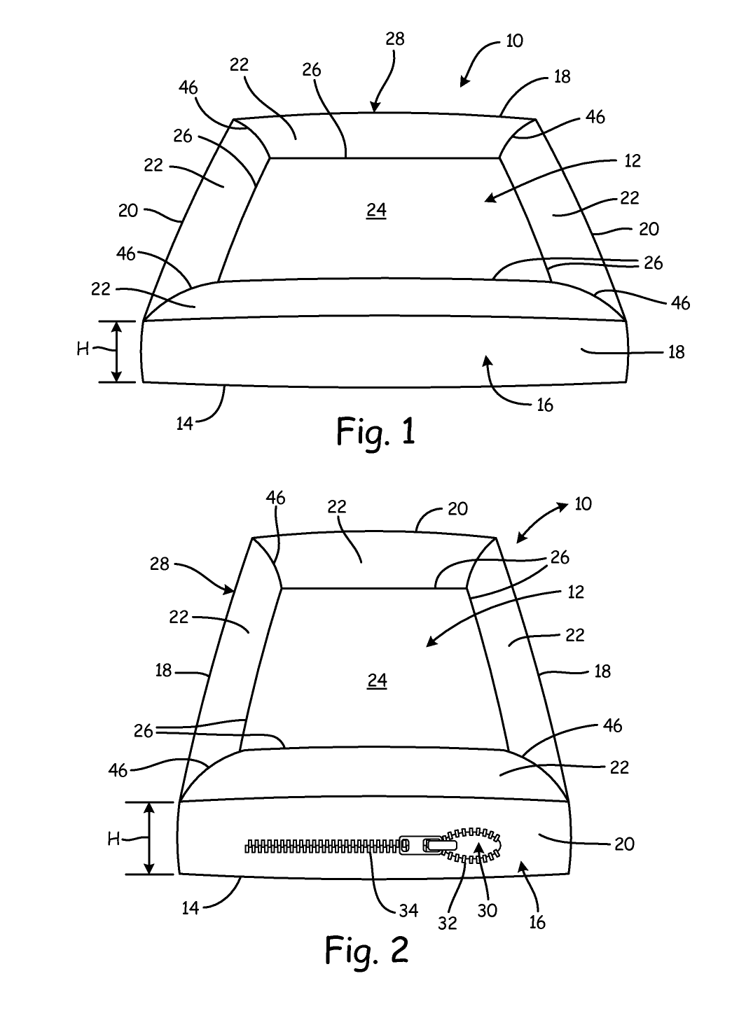

Exemplary embodiments of the present disclosure describe pet beds designed for ease of manufacture and so that fill material is prevented from shifting within the pet bed. FIG. 1 is a front perspective view of an exemplary embodiment of a pet bed 10. In an exemplary embodiment, pet bed 10 includes top surface 12, bottom surface 14, and perimeter side wall 16. In an exemplary embodiment, perimeter wall 16 is composed of a first pair of side walls 18 and a second pair of side walls 20. In the illustrated embodiment, pet bed 10 has a rectangular configuration; thus, the first pair of side walls 18 are parallel to each other, and the second pair of side walls 20 are parallel to each other. While four side walls 18, 20 are shown, it is contemplated that perimeter side wall 16 may be made of fewer or more side walls. Further, perimeter side wall 16 may possess any closed shape.

In an exemplary embodiment, top surface 12 includes a perimeter bolster area 22 and a central area 24. Valleys 26 may be provided between perimeter bolster area 22 and a central area 24 to delineate the areas and offer a pleasingly plump appearance. Moreover, valleys 26 may serve to help retain pet hair, dander and other shed material on top surface 12. In an exemplary embodiment, pet bed 10 has a substantially uniform height dimension H at perimeter wall 16 and at a central area 24. Accordingly, a pet resting on pet bed 10 does not have a tendency to roll off the pet bed 10.

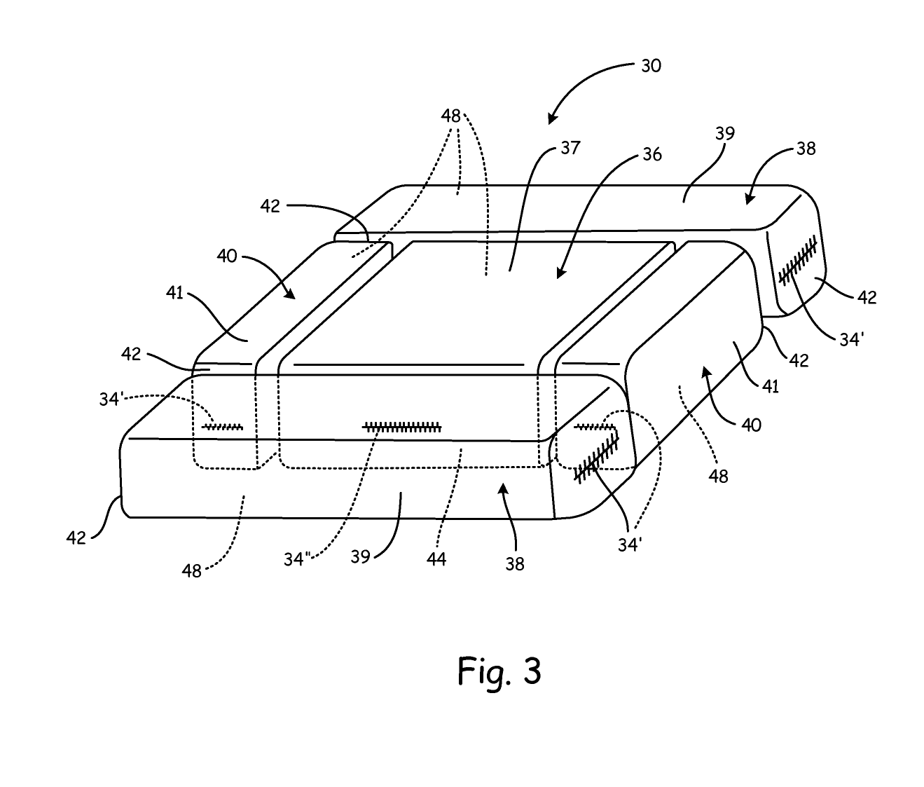

In an exemplary embodiment, top surface 12, bottom surface 14, and perimeter side wall 16 are parts of a shell 28 that is filled with an assembly 30 of cushion components, as shown in FIG. 3. As shown in FIG. 2, in an exemplary embodiment, shell 28 includes an opening 32 that has a closure device 34 for selective opening and closing, such as for filling or emptying shell 28 of its cushion components. Suitable closure devices 34 include zippers, hook and loop fasteners, clamps, clips, and buttons, for example. In an embodiment where one of the pair of side walls 16, 18 is longer than the other pair of side walls 16, 18, pet bed 10 in an exemplary embodiment has closure device 34 positioned on one of the side walls that is shorter. This results in a cleaner appearance on a longer side wall and allows for the use of a shorter closure device 34.

FIG. 3 is a perspective view of an assembly 30 of a single layer of cushion components for filling the shell 26 of the pet bed 10. In the illustrated embodiment, assembly 30 includes center cushion 36, first pair of perimeter cushions 38, and second pair of perimeter cushions 40. In an exemplary embodiment, each of perimeter cushions 38, 40 is elongated, with two opposing end surfaces 42. In an exemplary embodiment, one of the end surfaces 42 of each perimeter cushion 38, 40 is provided with closure device 34′. Similarly, center cushion 36 has side wall surfaces 44. In an exemplary embodiment, one of side wall surfaces 44 is provided with closure device 34″. Closure devices 34′ and 34″ may be similar to closure device 34, but sized for end surfaces 42 and side surface 44, respectively.

In an exemplary embodiment, closure device 34, 34′, 34″ can be selectively opened and closed repeatedly, though more permanent closing means such as stitches can also be used. Suitable closure devices include zippers, hook and loop fasteners, clamps, clips, and buttons, for example.

The illustrated embodiment of assembly 30 shows a longer pair of perimeter cushions 38 and a shorter pair of perimeter cushions 40. In an exemplary embodiment, each of perimeter cushions 38, 40 is elongated and is substantially in the shape of a rectangular prism. Together, the perimeter cushions 38, 40 form the filling for the perimeter bolster area 22 of shell 28. In the illustrated embodiment of shell 28 shown in FIGS. 1 and 2, miter seams 46 at the corners of perimeter bolster area 22 provide an attractive appearance. However, the substantially symmetrical construction of perimeter cushions 38, 40 offers a means by which to fill the perimeter bolster area 22 with simply shaped components that are easy to manufacture, handle and assemble together. Moreover, while the illustrated embodiment of assembly 30 shows a single center cushion 36, a longer pair of perimeter cushions 38 and a shorter pair of perimeter cushions 40, it is contemplated that fewer or more cushions may be used. Moreover, center and perimeter cushions having shapes different than shown may be used (e.g., the perimeter cushions 38, 40 may fit together with angled end surfaces 42 under miter seams 46).

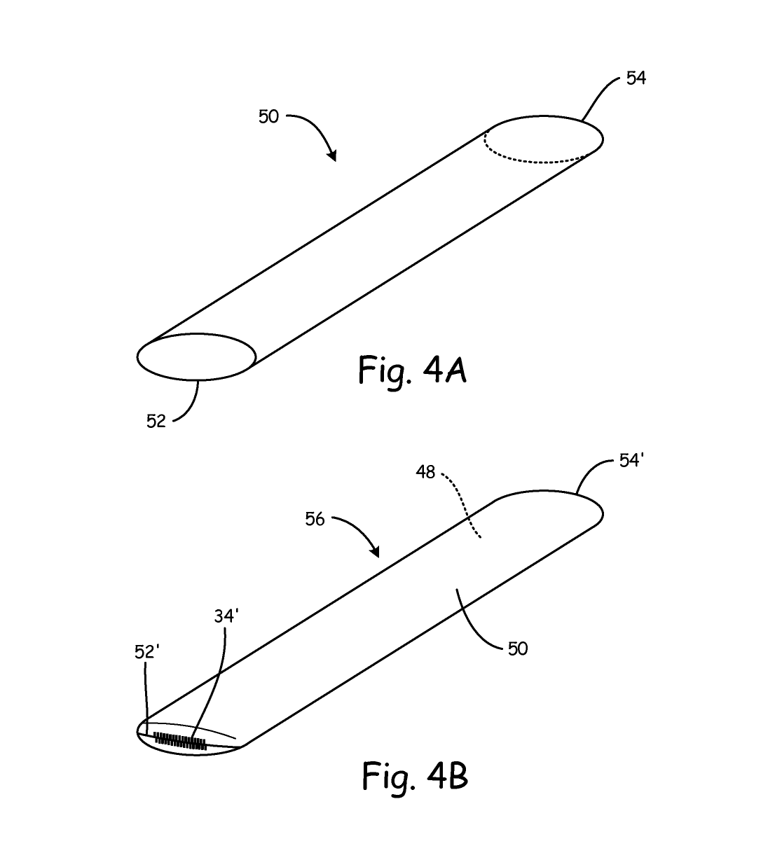

FIG. 4A is a perspective view of a second exemplary embodiment of a cushion construction using tubular casing 50. In an exemplary embodiment, casing 50 is formed from a non-woven polyurethane material. In an exemplary embodiment, casing 50 has first end 52 and second end 54. As shown in FIG. 4B, to form a tubular cushion 56 that can be used as center cushion 36, one or more of the first perimeter cushions 38 and/or one or more of the second perimeter cushions 40, each end 52, 54 is closed, as at seam 52′, 54′, for example. In an exemplary embodiment, one of the seams 52′, 54′ is provided with closure device 34′ or 34″. The structure of tubular cushion 56 is simpler than that of the more block-shaped cushions illustrated in FIG. 3 but serves the same purpose in assembly 30.

In an exemplary embodiment, each component of assembly 30 of cushion components, namely center cushion 36 and perimeter cushions 38, 40 (having, for example, the illustrated structure or the tubular structure of cushion 56) consists of a casing 37, 39, or 41, respectively, filled with a cushioning material 48. In an exemplary embodiment, the casing 37, 39, or 41, is formed from flexible sheet materials such as textiles and films. Cushioning material 48 may include polyester, polymers, cotton and other suitable synthetic and natural materials. Fibrous fill material is especially suitable for adding loft and softness to pet bed 10 while being light in weight. In an exemplary embodiment, fibrous fill material is a recycled polyester in crimped filament form. Fibrous fill material is typically supplied in a compressed bale of fibers having different lengths and crimp properties. As fibrous fill material is handled in a pillow filling blower machine, the machine opens up the fibers to allow air to occupy spaces between individual fibers. This air incorporation results in fibrous fill material having high level of loft, leading to a desirable softness and filled appearance when used in the casings of center cushion 36 and perimeter cushions 38, 40. A particularly suitable polyester fiber is siliconized to facilitate its movement through a blower machine.

Another suitable cushioning material 48 is a shredded foam fill material. Such a shredded foam fill material may be formed from polyurethane, and other suitable synthetic and natural materials. Shredded foam fill material is especially suitable for adding resilience to pet bed 10, while adding density, which helps to retain pet bed 10 in a desired location. In an exemplary embodiment, shredded foam fill material is obtained by recycling foam scrap materials that are left over from the manufacture of larger mattress and cushion pieces. The shredded foam fill material need not be uniform; for example, it may include pieces of foam having different densities. In an exemplary embodiment, the pieces of shredded foam fill material are similar in size to popped corn.

A combination fill material may also be used for cushioning material 48, including a mix of fibrous fill material and shredded foam fill material. In an exemplary embodiment, a combination fill material includes approximately equal portions of fibrous fill material and shredded foam fill material by volume, although other proportional mixes are also suitable. In an exemplary embodiment, the fibrous fill material and shredded foam fill material are evenly distributed among each other, in whatever ratio they are provided. More information on suitable fill materials is disclosed in commonly assigned U.S. patent application Ser. No. 14/303,186, entitled “Pet bed with combination filler and filler isolation barriers,” which is fully incorporated by reference herein.

In an exemplary embodiment, center cushion 36 is formed by filling center casing 37 with cushioning material 48. Each perimeter cushion 38 is formed by filling perimeter casing 39 with cushioning material 48. Each perimeter cushion 40 is formed by filling perimeter casing 41 with cushioning material 48. A method of constructing pet bed 10 includes filling each of center casing 37 and perimeter casings 39, 41 with the desired amount of cushioning material 48 and then closing closure devices 34′, 34″. In an exemplary embodiment, at least one of the perimeter cushions 38, 40 is inserted into opening 32 of shell 28 before center cushion 36 is inserted therein. The center cushion 36 and perimeter cushions 38, 40 are inserted into shell 28 through opening 32, thereby forming assembly 30 to be retained within shell 28. Closure device 34 is then closed to complete the assembly of pet bed 10. For extra cushioning, each of center cushion 36 and perimeter cushions 38, 40 may be over-filled. Because a casing 37, 39, or 41, of each of center cushion 36 and perimeter cushions 38, 40 is formed of a flexible sheet material, such over-filling will result in a pet bed 10 with a more rounded central area 24, more rounded perimeter bolster area 22, and more pronounced valleys 26.

Because center cushion 36 and perimeter cushions 38, 40 are separately formed and filled, cushioning material 48 from one of the components 36, 38, 40 of assembly 30 is prevented from shifting into another component. Therefore, pet bed 10 retains its shape for a longer period of use. Moreover, the provision of separate components in assembly 30 allows for the replacement of just one or some of the components of assembly 30, in the case where not all of the components require replacement (for example, if the pet soils, damages, or flattens just a portion of the assembly 30).

In an exemplary embodiment of pet bed 10, top surface 12, bottom surface 14, and perimeter side wall 16 are formed of flexible sheet materials such as textiles and films, for example. Especially suitable materials are durable yet soft. Other features may include a surface texture that assists in retaining shed fur or possesses a waterproof property, for example. Moreover, the different surfaces 12, 14, and 16 need not be made of the same material. For example, in one embodiment, top surface 12 is made from a plush or flannel fabric, while bottom layer 14 is made from a more durable twill, faux suede or vinyl material. Perimeter side wall 16 may be formed of a decorative material having an aesthetically pleasing design and/or texture, for example. In other cases, top layer 14 and bottom layer 16 are both made of soft materials, so that pet bed 10 is easily reversible for extended use.

In one exemplary embodiment, pet bed 10 is rectangular, with dimensions of about 36 inches in length, about 29 inches in width, and about 4 inches in height “H”. Such a pet bed may contain about 46 ounces of polyester blown fiber fill. In an exemplary embodiment, each of the cushion components of assembly 30 has a tubular construction, as shown in FIGS. 4A and 4B. The cushion components cover a larger surface area when flat and un-filled with cushioning material 48. When filled, the cushion components cover less surface area to accommodate a height dimension. An unfilled casing 37 of center cushion 36 has flat dimensions of about 29.5 inches by about 22.5 inches. An unfilled casing 39 of one of the perimeter cushions 38 has flat dimensions of about 39 inches by about 12 inches. An unfilled casing 41 of one of the perimeter cushions 40 has flat dimensions of about 28 inches by about 12 inches.

In another exemplary embodiment, pet bed 10 is rectangular, with dimensions of about 42 inches in length, about 32 inches in width, and about 4 inches in height “H”. Such a pet bed may contain about 60 ounces of polyester blown fiber fill. In an exemplary embodiment, each of the cushion components of assembly 30 has a tubular construction, as shown in FIGS. 4A and 4B. The cushion components cover a larger surface area when flat and un-filled with cushioning material 48. When filled, the cushion components cover less surface area to accommodate a height dimension. An unfilled casing 37 of center cushion 36 has flat dimensions of about 34.5 inches by about 23.5 inches. An unfilled casing 39 of one of the perimeter cushions 38 has flat dimensions of about 46 inches by about 12 inches. An unfilled casing 41 of one of the perimeter cushions 40 has flat dimensions of about 32 inches by about 12 inches.

Pet bed 10 can also be inserted into a separate pet bed cover (not shown). In an exemplary embodiment, such a cover has a selectively closeable opening, such as an opening closable with a zipper, buttons, clips, clamps, or hook-and-loop fasteners. Thus, the cover is easily removable for cleaning and replacement when desired.

Although the subject of this disclosure has been described with reference to several embodiments, workers skilled in the art will recognize that changes may be made in form and detail without departing from the spirit and scope of the disclosure. For example, while a rectangular pet bed 10 is illustrated, it is to be understood that pet bed 10 may be formed in other shapes and sizes, including but not limited to a square, circle, oval and fanciful shapes, such as a dog bone shape, for example. In addition, any feature disclosed with respect to one embodiment may be incorporated in another embodiment, and vice-versa.

What is claimed is:

1. A pet bed comprising:
an assembly comprising a plurality of separate cushion components; and
a shell containing the assembly.

2. The pet bed of claim 1 wherein at least one of the cushion components comprises a casing containing fill material.

3. The pet bed of claim 2 wherein the at least one of the cushion components comprises a selectively operable closure device.

4. The pet bed of claim 2 wherein the casing comprises a tubular construction.

5. The pet bed of claim 1 wherein the shell comprises a top surface, a bottom surface, and a perimeter side wall.

6. The pet bed of claim 5 wherein at least two of the top surface, bottom surface, and perimeter side wall are formed of different materials.

7. The pet bed of claim 1 comprising a central area and a perimeter bolster area.

8. The pet bed of claim 7 further comprising a valley at the interface of the central area and the perimeter bolster area.

9. The pet bed of claim 7 wherein the plurality of separate cushion components comprises a central cushion and a plurality of perimeter cushions.

10. The pet bed of claim 1 wherein the shell comprises a selectively operable closure device.

11. A method of assembling a pet bed comprising inserting a plurality of separate cushion components into an opening of a shell, thereby forming within the shell an assembly comprising a single layer of cushion components.

12. The method of claim 11 further comprising selectively closing the opening.

13. The method of claim 11 wherein the plurality of separate cushion components comprises a central cushion and a plurality of perimeter cushions, and wherein the method comprises inserting at least one of the plurality of perimeter cushions into the opening of the shell before inserting the central cushion into the opening of the shell.

14. The method of claim 11 further comprising forming each of the plurality of separate cushion components by filling a casing with cushioning material.
